(19) United States
(12) Patent Application Publication
(10) Pub. No.: US 2009/0261988 A1
(43) Pub. Date: Oct. 22, 2009

(54) System, Access Control Device and Method for Enabling the Exchange and Shared Use of Parking Spaces

(75) Inventor: Carlos Ramirez Serrano, Madrid (ES)

Correspondence Address: COLLARD & ROE, P.C., 1077 NORTHERN BOULEVARD, ROSLYN, NY, 11576, US

(73) Assignee: TUPLAZA MOVILIDAD Y DESARROLLO, S.L., Madrid (ES)

(21) Appl. No.: 11/992,254

(22) PCT Filed: Sep. 20, 2006
(86) PCT No.: PCT/ES2006/000525

§ 371 Date: Mar. 19, 2008

(30) Foreign Application Priority Data
Sep. 20, 2005 (ES) P200502295

(51) Int. Cl. G08G 1/14

(52) U.S. Cl. 340/932.2

(57) ABSTRACT

This invention describes a new system, device and method for the shared use and exchange of parking spaces, with controlled access between parking supply and demand entities, and specifically between individuals. The parking exchange system includes: i) a central platform to manage the operations resulting from the use of the associated parking spaces in terms of the registered supply and demand, ii) means to control access to the available spaces via the proposed device and its own coding system, and iii) methods and procedures for detecting, notifying and resolving the incidents arising from the irregular use of the managed parking spaces.

### OBJECT OF THE INVENTION

This invention refers to a system, access control device and a method for the exchange and shared use of parking spaces between supply and demand entities (affiliated individual users or parking garages) which, in association with a central platform, form a parking exchange in which the associated access management and control operations to the available parking spaces are managed by it.

The system, although it is applicable to rotating parking garages with intelligent access control systems, has been especially conceived to allow owners and/or users of parking spaces in residential estates to make their parking spaces available to other users affiliated with the system when they are not occupied on a semi-automatic basis.

Its use is particularly ideal for areas in which the availability of parking spaces on the streets and in publicly or privately managed intelligent rotating parking garages is insufficient or does not meet the price or hourly needs of drivers. In particular, the system described herein makes it possible to increase the number of available spaces in the area and the rate of use of parking spaces primarily located in residential estates, although it is also applicable to private or public parking garages whose customary users and/or owners are affiliated with the system.

### FIELD OF APPLICATION

The field of application of the invention is obviously part of the industrial sector that provides, manages and maintains parking spaces in general, either of a public nature or associated with residential facilities.

### BACKGROUND AND BRIEF DESCRIPTION OF THE INVENTION

The problems of mobility caused by the lack of parking in cities, and particularly in downtown areas, are known only too well. Parking spaces are divided between publicly or privately managed rotating parking garages, parking spaces on the street, normally subject to rotating schemes in large cities, and private and corporate parking garages.

In areas with a shortage of parking, drivers often face either an annoying search for spaces on the stress, with the detrimental effect of traffic congestion, the impossibility of parking for long periods of time in areas with regulated parking, or else the alternative of paying in high priced parking garages. This situation affects many drivers and particularly workers in these areas who use their cars to go to work and who often have to pay, either by a monthly ticket or else by time of stay, for a space in a rotating parking garage because of the impossibility of parking on the street for long periods of time.

The lack of parking resources means that it is of great interest to optimize the available resources in order to improve mobility and accessibility in these areas, often in the face of the difficult or costly investments required to equip them with new infrastructures for this purpose.

The available resources include the private spaces of residential communities. These spaces are often unoccupied by their regular users because they leave for work, take weekend trips, or other reasons.

Thus the exchange of potentially empty parking spaces in residential communities is underused, as there is no system that enables a semi-automatic exchange of these spaces between numerous users not necessarily linked to a single space or to a particular hour.

This invention provides a solution precisely to this problem, creating the necessary system and device to enable an exchange of spaces between those persons or entities offering spaces when they are unoccupied and the drivers requesting those spaces. Although the system focuses on parking located in residential communities, it is also applicable to existing rotation parking garages.

The system of the invention enables the mass organization of the shared use of already existing parking spaces by putting on the market an easy, cheap way to exchange underused parking. This is of particular interest to those drivers who can predict their movements and to those users or owners of parking spaces who, as compensation for ceding the space during unoccupied periods, can access the rest of the parking exchange in any other area or receive an equivalent economic incentive.

As we will see, a key aspect of the solution focuses on preventing the misplacement and copying of keys or remote controls, and on preventing the installation of new access control equipment in the associated resident parking garages, in order to permit a plural use of the available parking spaces with a view to allowing any user access to any parking space of the system through an access control device.

Moreover, the current state of the art already includes numerous known developments of parking and access control systems. Most of the developments in this field have been intended for premises with access control and paid parking, i.e. rotating parking garages that are equipped with, or require, the local implementation in each facility of intelligent systems with their respective database applications, access control and payment devices, and software applications for management thereof.

These systems have been developed in order to enhance the features and convenience for the users, offer them new information and parking space reservation services, and increase the access convenience and security and the security of the vehicle during the time it is parked there.

In addition, both for controlled access parking garages and for parking located on the street and subject to inspection by the authorities, i.e. regulated parking areas, the invention has also pursued a decrease of fraud, improvement of the control and inspection procedures to verify that the applicable parking regulations are met, and the provision of new payment possibilities for users through dedicated terminals, ID cards or mobile devices such as PDA type electronic agendas or mobile phones.

On the other hand, the manufacturers of access control systems for the residential market, which initially are not intended for the rotational use of garage spaces but rather for their regular owners or users, have adopted simple access control systems, most of them operated by radiofrequency. These include the use of a transmitter or remote control and a receiver located on the access door that validates the open door signal.

As we will see hereinafter, the characteristics of the developed systems, the most relevant of which are mentioned below, do not allow for establishing a system of controlled, semi-automatic exchange of garage spaces between individuals whose parking spaces are located in premises controlled by a radiofrequency-based access system.

For instance, a system to promote the exchange of parking spaces has been described in document JP-2003216988. This is no more than a simple form of intermediation via an Internet portal to help reach agreements on the shared use of a single space between regular users. This system does not include, however, an element of utmost importance, i.e. a necessary procedure and device to enable access to the spaces that are agreed to be shared, and therefore it does not enable an exchange and occasional access between plural users to different parking garages.

Parking space reservation systems have also been described for intelligent rotating parking garages, e.g. in documents US-2002077953, US-20044254840, WO-02/33675 and WO-02/097736. These systems have been designed for rotating parking garages and have numerous limitations for use as systems dedicated to the shared use of parking spaces in residential garages. On one hand, for the control of the access functions linked to a previous reservation, these systems require the installation of some kind of device in parallel to the customary systems of access to the parking garage, e.g. systems of bar code reading, cards with or without contact, voice recognition, license plate recognition, keyboards, Bluetooth type wireless data exchange or similar. Moreover, the management of reservations is based on the control of the level of occupation of the parking garage and not on the supply of spaces by periods established by the users themselves, the management of which requires excessively complicated systems that entail the use of system architectures that link numerous devices and servers for hosting the logic associated with the reservations control in accordance with the parking control operations and systems. Therefore, the complexity of these parking space reservation systems makes them economically unviable for implementation in residential environments, whose radiofrequency-based access systems are relatively simple and cheap and do not support intermediation with the reservation systems described above without installing other more complex control and communication devices and means in each associated parking garage.

On its part, document ES-1 047 775U describes a system for hotel reservations with an access control system that can be remotely configured via the telecommunications network. This document includes a description of the blocks needed to implement a remotely controlled variable code access system in order to prevent keys from being passed between the different customers who occupy the premises to be controlled. Again, in this model, the access blocking or enabling functions, such as the remote updating of the entrance codes, are made to reside in a terminal to be installed on the premises. Again this requires the installation of the necessary electronic device on the premises whose access is to be controlled and of communication interfaces with the central system in charge of managing the access.

There are other documents similar to the latter one mentioned above, e.g. documents US-2004036573 and WO-1/52053 which describe garage door access control systems for the residential market. These documents more precisely detail the configuration of the terminals required in the garages and the access operations they perform but, just as in the case of above mentioned document ES-1 047 775U, they require the installation of a complicated electronic system in the garage, with a communication interface with the external provider of remote access management services; therefore, although they do prevent the misplacement of keys, they do not resolve either the drawbacks mentioned above regarding installation and costs associated with the necessary communications.

In the case of this invention, its aim is precisely to devise a new specific system for the low cost exchange of parking spaces which avoids both the need to install new access control equipment on the premises to be controlled and the misplacement of keys or remote controls belonging to the premises, and which in turn allows the users to determine the periods of occupation of their spaces for managing their exchange.

In the system of the invention, the access control functions reside in a new portable device compatible with most of the systems already installed in residential accesses. This new device enables or blocks access on the basis of an internal coding system actuated via an access code associated with an exchange operation that is sent in the form of an electronic ticket to the user. In this way, there is no need to install new equipment on each of the premises, to change the access parameters of the existing equipment, or to remotely update the authorized entrance codes in a device installed in the garage.

As will be seen below, this is possible for numerous places which already have a radiofrequency access control system of the kind used in residential garages, i.e. by remote control.

In fact, there are known remote controls in the state of the art that are based on the transmission of a radiofrequency signal to trigger the opening of locks used in the residential market. Each manufacturer distinguishes its remote controls by the operating frequency in the authorized band, the modulation scheme used to transmit the signal, and the code sent from the transmitter to the receiver. Since the appearance of these radiofrequency equipments, the coding of the digital signal transmitted between the transmitter and receiver has become more complex, with the emergence of each manufacturer's own modulation modalities, improvements in encryption, or coding of the signal by means of keys between the transmitter and receiver and evolutive code controls, for the purpose of offering more secure access systems, some of which are virtually impossible to copy.

On the other hand, the competitive nature of the market, the need to replace discontinued transmitter models without the need to update the receiver and the need to lower costs have all given rise to practically universal compatible controls capable of replacing numerous models of different manufacturers and interacting with already installed receivers.

These universal controls make it possible to replicate the remote control signal of numerous manufacturers by reproducing the coding sequence, provided this sequence is fixed, in different ranges of modulation and frequency.

There are various methods and electronics required to replicate the signal used to operate a control. There are controls that incorporate dedicated electronics for the detection, copying and reproduction of the signal from an original control (see documents U.S. Pat. No. 5,661,804, U.S. Pat. No. 5,442,340 and WO-00/75905). Others are programmable by an external programmer designed for this purpose, which inputs the parameters that define the signal, and there are also controls that include a programming stage integrated into the control itself to select the pertinent transmission signal via a keyboard (document U.S. Pat. No. 4,890,108) or micro-switches (documents U.S. Pat. No. 6,486,795 and U.S. Pat. No. 5,564,101).

Since the manufacturers use a limited number of frequencies, modulation schemes and coding, the existence of universal controls, such as those mentioned in the preceding paragraph, to open different accesses is known and relatively frequent.

It should be noted that, in the case of evolutive controls, the variable nature of the codes has impeded the creation of fully universal controls. Nevertheless, some manufacturers (see document U.S. Pat. No. 5,661,804) have now developed practically universal controls compatible with a significant number of evolutive code control manufacturers. To do so, it is necessary to know the parameters required to generate evolutive codes, such as the production algorithms of security codes and keys by means of agreements with the original manufacturers. Another method for copying evolutive controls is to take advantage of the fact that evolutive controls in some cases include synchronization and resynchronization modes between the transmitter and receiver that convert an evolutive code into a fixed opening sequence that is valid under certain circumstances; this enables the replication of an evolutive control if the fixed opening sequence of a transmitter-receiver pair with evolutive technology, formerly impossible to copy, is known or can be derived by reverse engineering.

These controls, although they can be used to replace the originals, cannot establish an access control logic remotely governed by an external reservation platform. In fact, controls such as the ones described in document U.S. Pat. No. 6,486,795 or document U.S. Pat. No. 5,661,804, can be used, once purchased by the user, to reproduce the transmission sequence of a transmitter-receiver system by merely following the programming instructions that govern their coding stage, and even to program several RF access control systems in one and the same control.

However, the functioning of the coding and programming stages of the radiofrequency signal to be transmitted by these controls does not make them suitable for implementing an access control system to different premises with already installed RF receivers. This is because their design does not incorporate in the control itself a control logic or the functional blocks for linking an externally validated reservation to the control operation so that the control can interpret, with data remotely generated by an external platform, i.e. the access code input into the control, whether or not it is advisable to actuate an open signal and the form that this signal should have.

In other words, the control electronics and logic of these controls, although they can replicate the operation of many of the RF controls on the market, cannot link this operation to an externally authorized reservation request.

Nevertheless, the manufacturers of access control systems have created specific transmitter-receiver procedures and systems to permit and control an occasional access by third parties other than the regular user; with an appropriate terminal, they can temporarily access premises controlled by a radiofrequency system, e.g. to distribute merchandise or maintain the control systems, without the need for the regular user to be present and limiting the access by renewable time intervals to authorized users. Systems of this kind have been described in documents US-2004036573, WO-01/52053 and EP-1 149 361. Again, and just as in the case of the systems developed for intelligent rotating parking garages, these access control systems need to incorporate new kinds of receivers and devices in which the remote access control functions again reside and whose installation on the premises to be controlled is therefore of a complex nature.

In short, there are various limitations of the systems explained above for the purpose described herein, including the main ones mentioned below:
a) On one hand, the existing systems, even though some of them can be used for the exchange of parking spaces, require the installation of specific high cost, high maintenance intelligent systems on the premises where there is a user who wishes to exchange his space. This represents a fundamental barrier to the implementation of a dynamic parking space exchange system in residential community garages due to the cost factor and the resistance to installing new access systems by other residential community users who are not interested in exchanging their spaces.
b) As for the use of existing remote control terminals, including the universal ones, these cannot be configured to replicate different signals that provide access to various premises, typically residential communities, with different radiofrequency control systems that are already installed and in a way that authorization of this access is also managed remotely according to the parking needs of a requesting user and the availability of spaces associated with an exchange system.
c) The existing systems lack a control platform that can transmit valid access codes which include information on an authorized reservation and whose logic, interpreted by the access control device proper, puts the latter into operation only in authorized cases in order to reproduce, via the suitable electronics, an access signal compatible with already installed reception systems through a universal radiofrequency transmitter, and only when it is in accordance with the characteristics of the authorized reservation (period, customer, destination, . . . ).

For purposes of enabling a simple, dynamic exchange of parking spaces between users affiliated with the management platform, the system proposed by the invention solves the above described difficulties.

The solution proposed by the invention is to provide the users affiliated with the exchange system with an access control device (hereinafter, abbreviated to ACD), which functions as a universal remote control compatible with the majority of the radiofrequency systems already installed in the accesses to residential community garages. This device, which either directly receives or in which the access codes (hereinafter, abbreviated to AC) issued by the parking space exchange management platform in accordance with the established parking space management policy are easily input, is used to manage the access control to reserved spaces in different premises.

In this way, users can make their parking spaces available in unoccupied periods through the platform and its different access channels, e.g. Internet, voice recognition interface and telephone. If they are also in possession of the above mentioned ACD, they will also have access to reserve and occupy spaces made available by other users in other premises.

The interest is obvious because, by merely registering with the platform and having the appropriate ACD terminal, such a system would permit the dynamic, mass exchange between residents of parking spaces located in different parking garages, which is of particular interest in areas where there is a shortage of parking.

In addition, in order to incorporate professionally operated rotating parking garages into an eventual exchange of parking spaces between their users, and to enable them to operate as system bidders linked to the exchange platform or to operate as a backup resource of spaces, i.e. for meeting parking demands that are not satisfied by private resources offering spaces in residential communities, this system includes complementary procedures of execution and an additional receiver device for tailoring the control systems of the rotating parking garages to the requirements of this parking space exchange system which is primarily intended for residential garages.

The applicant is not aware of the existence of a management and control system such as the one proposed by the invention, the characteristics of which are described in more detail below.

### BRIEF DESCRIPTION OF THE DRAWINGS

These and other characteristics and advantages of the invention will be more clearly explained in the following detailed description of a preferential form of execution, provided only by way of an illustrative, non-limitative example with reference to the accompanying drawings, where:

FIG. 1 shows a general diagram of the operating principle of the invention system;

FIG. 2 shows a block diagram corresponding to an access control device implementation;

FIG. 3 shows a schematized view of an execution example of an access control device (ACD), and

FIG. 4 is a schematized view of an execution example of an ACD device made in the form of a key ring.

### DESCRIPTION OF THE PREFERENTIAL FORM OF EXECUTION OF THE INVENTION

As discussed above, this invention aims to provide a new access control system, method and device to enable the shared use and exchange of parking spaces between system users, where the latter are either individual users or parking garages. The users affiliated with a central platform make up a parking exchange in which the access management and control operations to the available spaces are managed by it.

Therefore, the purposes. of the invention can be defined as follows:
provide a method and a device to exchange garage spaces between registered users that are easy to implement and use and are reasonably priced;
provide a method and a device to exchange garage spaces between registered users that do not require the implementation of new access control systems and devices in residential garages to be able to exchange spaces between multiple users;
provide a method and a device to exchange garage spaces between multiple users in a way that prevents the misplacement of copies of the remote controls required to control access by radiofrequency to the exchanged garage spaces;
provide a method and a device based on a radiofrequency access control system compatible with the radiofrequency access systems available on the market;
provide users with the means to notify the availability and authorize the use of their garage spaces, when they are not being used, to other registered users;
provide a method and a device to users requesting a space to reserve and access the unoccupied spaces in the time periods notified by the offering users;
provide means to encourage registered users to make their spaces available to other users when they are not occupied;
provide means to bill the use of the spaces reserved by the users;
provide means to notify and identify the incidents or conflicts related to the use of spaces registered in the system;
provide a method and a device compatible with the one used to exchange spaces between users of residential garages to access spaces made available to the system by rotating parking garages.

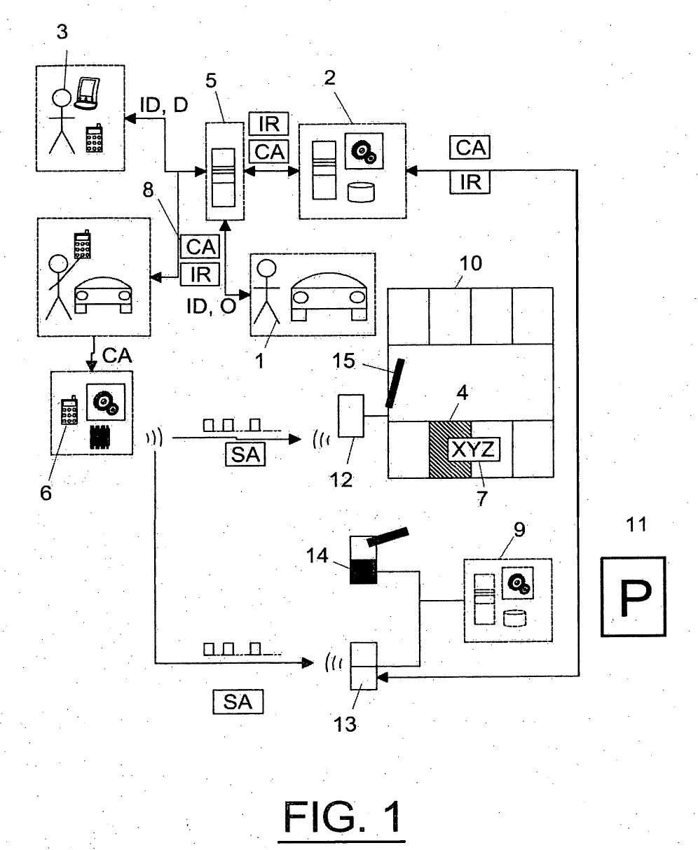

In the general schematized view shown in FIG. 1, it can be seen that the general scheme of the invention is composed of: i) a central platform (2) for managing the exchange of spaces depending on the available supply and the demand for parking with multi-channel access media (5) for system users to input the data on the parking supply and demand; ii) an access control device ACD (6) which, when actuated by the system users via an access code AC previously generated by the platform (2) in accordance with the characteristics of a specific space reservation, transmits an open signal OS, which is compatible with the radiofrequency access system of the destination parking garage in order to enter and exit it.

The general operation of the platform is as follows:

The offering user (1) identifies himself and notifies to the space exchange station (2) the availability of his space (4), or of spaces located in a parking garage (10), in accordance with the parameters required by the station (2). The parameters that define the characteristics and availability of a space include geographical location, localization in the garage, size, the period and hour of availability, and the price. These parameters are associated with the identity of the user offering the space and include data on the person, contact details such as telephones, e-mail and address, and data on the vehicle that normally occupies the space such as license plate number, brand and model.

According to a preferential method of execution, the offered space (4) may have a fixed display device (7) to identify it for the requesting users (3) once they have accessed the parking where it is located with their vehicle. This visual device contains a logotype reference of the exchange station or an alphanumeric reference, e.g. the offering user's vehicle license plate (3) in the form of a sticker or plaque conveniently placed on the wall, floor or ceiling of the space in order to make it easier to read from a vehicle driving through the garage.

According to another mode of execution, the offering user can be a parking garage operator (11), in which case the spaces (4) may not be specifically identified inside the parking lot (11), or they may be identified with visual identification methods such as those normally used in rotating parking garages, with fixed or variable signals, illuminated panels and similar.

Another descriptive aspect of the system are the means used by the offering user (1) to notify the availability of spaces to the platform (2). The offering user (1) makes the availability of his space known through fixed or wireless communication networks with a PC type multimedia device, electronic agenda, or fixed or mobile telephone.

For purposes of inputting or updating the supply of spaces and their availability via different channels for electronic processing in the exchange platform (2), the latter is provided with a multi-channel communications portal (5) for communication of data between the users (1) and the platform (2). This portal (5) enables data communication, either via an Internet portal or else via telephone by means of recognition systems of data received by SMS text messages or by means of a voice recognition interface or by telephone pulse or tone data recognition, making it possible to take calls on an automated basis or through a platform operator (2).

The offering user (1) is identified by inputting unique user identification data, the ID reference in FIG. 1, which may vary according to the channel used, e.g. the car license plate and the user key, or e-mail and user key, or name and user key.

During the process of offering a space, a user (1) already registered in the platform (2) will normally only need to update data corresponding to the availability of the space with indication of day, month and year of the beginning and end of availability (dd/mm/yy), and the hours that define the period to begin and end the space exchange (hh:mm (beginning)-hh.mm (end)).

In the exchange station (2), the records of the offering user's data and the availability of his space are related and updated through a database.

On the other hand, the requesting user (3) should define a space occupation request and/or reservation and notify it to the platform (2) according to the parameters established in the exchange platform. The parameters that define the space reservation characteristics may include its geographical location, requested period and hour of occupation, the size of the requesting user's vehicle and the price. These parameters are associated with the identity of the user requesting the space, which include data on the person, the vehicle and contact data such as e-mail, telephone number and ACD associated with the user (3) for sending the ACs.

The means used to request a space reservation and the identification of the requesting user are similar to the ones described above for offering users.

In the exchange station (2), the records of the requesting user's data and the availability of spaces are related and updated through a database.

During the reservation process, means are provided for the geographical localization of a requesting user (3) when this user requests a reservation by mobile phone, in order to match the supply of available spaces to the user's position. The user position is localized with a localization system based on triangulation of the signal of the mobile phone and the surrounding base stations of the telephone operator. This system is not described here, as it pertains to a player outside the system with a well known commercial operation. For purposes of enabling the necessary localization, the multi-channel communications portal (5) of the platform (2) contains means for recognizing the call number, and the platform (2) contains means for connecting to third-party servers in order to request and receive the localization of the requesting user's telephone (3) from the telephone operator. For this purpose, the requesting user (3) will have previously registered the necessary data in the platform (2), e.g. the mobile phone number for localization, as well as the prior localization authorizations as specified by his telephone operator.

The exchange station (2) that receives the offers of available spaces (4) and the demands of users (3) contains means to process this information via a database, and to communicate to the requesting user (3) the offers of available spaces, in accordance with the request for reservation and in the format suited to the reservation channel used by the requesting user via the communications portal (5) (voice, Internet, text messages).

According to an aspect of the invention, the platform (2) provides the subscribed users (1) or (3) with means to consult the historical of demands and occupations they have made in other offered spaces, or to consult the demands made by other requesting users (3) in the space they offer, as well as means to block the execution of their own future reservations in spaces offered by other users or to block the execution of reservations by requesting users who have previously occupied their offered space.

According to the operating mode, if there are no available spaces (4) coinciding with the details of the reservation request, the requesting user (3) is notified of the available spaces that come closest to the characteristics of the reservation according to geographical proximity, hour and price.

During the reservation process, it is required that a space be selected from among the possible spaces offered by the system and that. the requesting user (3) confirm, so that the platform (2) can generate an access code AC (8) and a reservation identifier RI, as shown in FIG. 1.

This access code AC is unique for each defined reservation and assigns an available space (4) of a parking garage (10) or (11). According to an important characteristic of this invention, as will be detailed hereinafter, the access code AC contains information frames of variable configuration according to the destination garage, with reservation and user parameters and parameters that determine the actuation functions of the access system of the premises where the reserved space (4) is located, which can be actuated by means of the ACD to open and access the garage.

The exchange station (2) sends this access code AC (8) to the requesting user (3), along with the details that characterize the reserved space and the reservation identifier identified as RI in FIG. 1, which is an alphanumeric frame.

According to a characteristic of the invention, the access code AC is sent to the requesting user (3) for input and actuation in the ACD via fixed or wireless communications networks.

The platform (2) sends the access code AC, as well as the characteristics of the reserved space and the reservation identifier RI, according to the reservation channel used by the user (3). The details that characterize the space may include the space localization, its geographical location, position in the garage and reference to the data of the fixed display device (7). Thus the AC, RI and characteristics of the reserved space can be notified to the user in the form of text, images, URL readdressing or voice notification, according to the reservation channel used by the user (3). The means used to send the AC, reserved space information and reservation identifier RI therefore include: e-mail, data file downloadable from Internet, readdressing to a URL address that displays on the screen the multimedia device used for the reservation or for sending the text message to the mobile phone of the user (3), or telephone voice notification.

For purposes of sending the AC, the RI and the characteristics of the space reserved via mobile phone channel, the data of the user's AC receiving device are previously registered in the platform (2), along with the user's mobile phone contact number.

According to one execution mode of the invention, the access code AC can be sent directly to the user ACD if this device is equipped with a data reception circuit (16). The receiver (16) of the ACD, which acts as a data interface with the platform (2), can be any type able to receive messages via a radio-messaging service, which include, by way of a non-limitative example, RDS receivers, localizers and DAB (Digital Audio Broadcasting) radio receivers. To this end, the platform (2) contains the transmission media or means of interaction with external operator servers to send radio-messages and it has the receiver identifier number (16) recorded, as required by type RDS, DAB or radio-localizer, for transmissions addressed to it.

The requesting user (3) receives this access code AC and inputs it into the access control device ACD (6) in order to actuate it and subsequently access the reserved space.

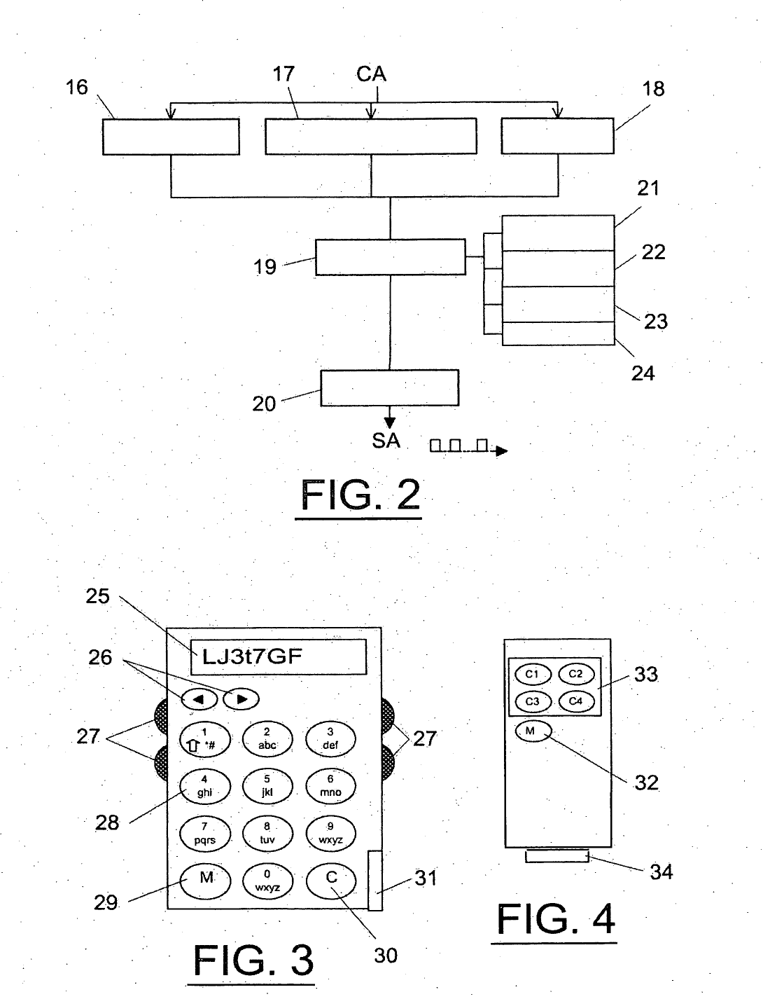

With reference to the ACD schematized in FIG. 2, it can be seen that it is equipped with means to input the access code AC, means for transmitting an open signal OS, and means for processing the intermediate internal operations between reception of the AC and transmission of the OS, as well as means for data storage. According to a preferential, non-exclusive execution, the ACD is composed of a keyboard (18) to execute the functions of input, actuation, storage and retrieval of an AC; a microprocessor circuit (19) for processing the intermediate operations for converting an AC into an open signal OS; data display means such as an LCD screen (24); memory supports (23) for storage of intermediate computing variables in the conversion of the AC signal into OS, or for storage of data tabulated in the ACD that are required for the intermediate operations, or for storage of usual ACs. Likewise, the ACD is provided with means that are customary in electronic devices, such as a battery (21) and an internal clock (22) with information on the date and hour, and means for the transmission (20) of a radiofrequency open signal OS.

The input of the AC into the ACD (6) is the programming and actuation method of the ACD radiofrequency stage (20). The ACD only contains the reverse functions for decoding the AC in order to actuate the open signal OS via the radiofrequency transmitter block (20), as will be described hereinafter.

According to a preferential model of execution, the user (3) inputs the AC through the alphanumeric keyboard (18), which is displayed on the ACD screen (24).

FIG. 3 shows a specific, but non-limitative, execution example of an ACD device, according to a schematized plan view of this device, in order to illustrate how it works. The physical execution of the ACD in FIG. 3 shows an ACD with a screen (25) for displaying data and specifically the AC, keys to move the screen cursor (26) and to delete characters (30), alphanumeric keys (28) to input an alphanumeric AC, keys to actuate an AC via different channels (27), keys (29) to retrieve the last access codes AC actuated in the ACD, and connection ports (31).

According to this mode of execution, when the AC is keyed in with the keys (28), the user presses a channel key (27) to actuate ACD operation according to the previously input AC and enable the transmission of an open signal OS. The actuated AC is also filed in the memory block (23) and associated with the channel actuated by the previously pressed key (27), such that successively pressing on this key (27) will retrieve the AC actuated with it. This characteristic of the invention enables the user (3) to key in and actuate a particular AC whenever he wants to use the ACD to open a garage with only one press of the key (27), which retries from the memory (23) the AC code previously used through that channel.

Thus the user (3) can record access codes that control receivers (12) of different entrance and exit doors of the same garage or different garages in different keys (27) associated with different transmission channels. The user (3) can also store the regular access codes of the access system of his own garage in the keys (27) and actuate them with a single stroke.

Likewise, the ACD contains memory (23) retrieval functions, via the keyboard (18), by using the key (29) of the last actuated ACs.

Other means to input the AC into the ACD, whose functional diagram is shown in FIG. 2, depend on the ACD execution mode. This may include several possibilities of AC input according to the blocks shown in FIG. 2, e.g.: a keyboard (18), connection ports (17) and a radio type receiver (16), or a combination of these.

Therefore, according to another non-limitative mode of execution, the ACD can be equipped with connection ports (17), such as the USB, Bluetooth wireless or infrared types, as a data transmission interface with other PC type multimedia devices, electronic agendas and mobile phones, in order to transfer the AC received in the latter to the memory support (23) of the user (3) ACD.

According to another execution mode, the ACD can even be equipped with radiofrequency-based data reception circuits (16), such as, by way of a non-limitative example, RDS or DAB (Digital Audio Broadcasting) receivers or the types used in radio localizers, for direct reception of the AC and its storage in the ACD memory support (23).

Of note is the fact that, according to the ACD data reception mode, the keyboard (18) and the screen (24) can be executed in different ways, so that the user (3) can operate the functions for input, actuation, storage and retrieval of an AC through the different channels. In Access Control Devices with AC reception via receiver block (16) or connection ports (17), it may not be necessary to have typical alphanumeric keys (28) to input the code by manual strokes. FIG. 4 shows on a particular, but non-exclusive, basis an example of another ACD execution mode, configured as a small, key ring type programmable remote control without a display screen.

According to the execution in FIG. 4, the access codes can be input into the ACD via the communications port (34), e.g. a USB port, in recordable, separate memory directories in the block (23) that represent each ACD transmission channel. According to this example, the communications port (34) is used to input, from PC type devices or electronic agendas, the AC codes into the different channels of the control or even to input the AC from a separate ACD device programmer. An ACD device programmer may be similar in appearance to the ACD in FIG. 3, but the transmission stage RF 20 has been eliminated in it and the connection port (31) [(17) in FIG. 2] is used to input the ACs keyed into the programmer into the memory blocks (23) of an ACD such as the one in FIG. 4.

In the ACD in FIG. 4, the keys (33) are pressed to retrieve, decode and actuate the AC code previously recorded in the corresponding memory block (23) for transmission of an open signal OS. FIG. 4, while not limitative in terms of number of channels, has 4 channels—C1 to C4—represented by the block of keys (33), to program up to 4 ACs in different transmission channels.

The key (32) is a memory key for retrieving the last codes actuated in the programmable transmitter block of FIG. 4.

In this way, the user (3), on actuating one of the keys (33), will with a single stroke start the transmission stage in accordance with the AC recorded in that channel.

The ACD contains a microprocessor (19) that may be standard or specifically executed, as well as means of memory support (23) for permanent data storage, e.g. an EEPROM memory, and a RAM memory for the intermediate variables and ROM memory (for the serial number of the control and the processes used in AC decoding to convert it into an OS).

To specialists in the field, it is obvious that the functional blocks in FIG. 2 can be those customarily used as components in other electronic devices, e.g. USB type data storage memories and even other types of electronic devices like DAB receivers. Thus, one execution mode of the ACD may include a combination of the electronics of these devices with a radiofrequency block RF 20 and an appropriate keyboard, as well as customized programming of the firmware of the device in question for control of the access system functions proper, thus providing the user with a multipurpose device for opening garage doors and usable for other applications, e.g. data storage, in the case that it involves a USB type volatile memory, whose execution is shown in FIG. 4.

Now a description is provided below of the coding operation associated with the system of the invention. For this purpose, the requesting user (3) actuates the ACD (6) to transmit the open signal to the garage where the reserved space is located. Once the AC is actuated, the ACD (6) decodes the access code, checks that it contains the data that authorize the transmission of an access signal OS, and transmits the access signal compatible with the garage where the reserved space is located for both entering and exiting the garage.

According to the invention described herein, these functions are controlled by the ACD via its different functional blocks described above. The general AC decoding functions for conversion into an open signal OS are detailed below.

As explained above, the purpose of this invention is to facilitate the exchange of parking spaces between users without the need to install new access devices on the premises and thus prevent the misplacement of keys. Until now, this has been described in this invention on the basis of a programmable ACD by an access code AC transmitted by a platform in charge of managing the exchanges of parking spaces.

The access code AC is composed of a series of data frames encrypted by a secret key K where AC=function (D, Ma, CV), and where D, Ma, CV are the different parameters that govern operation of the control.

Frame D includes information on the period of validity of the AC and on the serial number of the ACD to which the AC is sent. This frame D is used in the ACD actuation process in order to enable synthesizing and transmission of the OS signal whenever the serial number and period of validity data included in it correspond to the serial number prerecorded in the memory supports (23), the ACD control and the data of the internal clock (22) of the ACD.

The period of validity is a time period of use represented in the data frame D of the access code AC which may be daily or any combination of days within longer weekly, monthly or yearly periods.

The serial number of the frame D includes partial information on the serial number of the ACD to which the AC code is sent.

Frame MA provides information on operation of the garage access system (12). The information contained in MA is composed of those parameters pⱼ used to synthesize the open signal OS from basic parameters such as: i) the transmission frequency, ii) the data modulation scheme, including: the work cycle, how the “zeros”, “ones” or the signals “+”, “zero” and “−”—typical of binary and trinary coding controls, respectively—are represented in that cycle, the type of modulation ASK or FSK, and the parameters that, according to this modulation, define the “zero” and “one” data for binary coding or the “+”, “zero” and “−” data for trinary coding, iii) the type of coding, either fixed or evolutive and binary or trinary, and iv) the signal beginning and end header that may include, for example, a typical manufacturer sequence.

According to the execution mode, frame Ma is therefore a function of the type Maⱼ=f(pⱼ), identifiable by the ACD, in which it is indicated if the parameters pⱼ are predetermined and recorded in the memory supports (23) of the ACD, or if they are transmitted in frame Maⱼ itself.

According to this characteristic, the ACD can receive AC codes, identify the type of frame Maⱼ, and retrieve the parameters pⱼ from the memory supports (23) of the ACD itself, or else directly read them from the AC function Maⱼ, in order to use them for synthesizing the open signal OS compatible with the access system (12).

Frame CV is a data frame CV=f (CCi), which indicates the code(s) CCi to be modulated by the ACD in the open signal OS to emulate the open signal of an original remote control of the access system (12). Frame CV itself indicates whether the CCI(s) is(are) predetermined and recorded in the memory supports (23) of the ACD, or whether it(they) is(are) transmitted in the frame CV proper of the access code AC. For this purpose, the ACD is provided with means to identify the type of frame CV and thus retrieve the CCi from the memory supports (23) or else directly read them from the function transmitted in the CV.

For example, in the case of fixed code controls, the ACD emulates the open signal of an original control based on a single code CCi, where the open signal takes on the form OS=f(pⱼ, CCi), where OS is synthesized from the parameters pⱼ obtained from the frame Maⱼ and in whose OS a single CCi is modulated. This CCi, for fixed code controls, usually has between 6 and 48 bits, according to the access system model (12). For example, fixed code remote controls programmable by micro-switches have codes ranging from 6 to 13 positions and can be coded in binary or trinary, according to the remote control-model, which is equivalent to an information frame CCi in binary base from 6 to 20 bits. The controls whose fixed code is recorded in the chip usually have longer modulated codes CCi, from 20 to 48 bits, although there are also longer ones.

In the case of some evolutive controls, as explained hereinafter, the ACD makes use of several CCi to synthesize an open signal that actuates, as if it were an original remote control, the access system (12). In fact, evolutive code remote controls are usually synchronized with the receiver of an evolutive access system based on a counter than changes with each actuation of the control and that is transmitted in the modulated signal between the transmitter and receiver. When the transmitter desynchronizes, which usually happens if it is actuated repeated times in the absence of the receiver, certain models of evolutive controls can resynchronize the transmitter and actuate the associated receiver if, on successively pressing the control, codes are sent which, as they are evolutive, have an evolution sequence of the logic counter in accordance with its manufacturer. This makes it possible to reproduce an evolutive control through a process of desynchronization and resynchronization of the control with the receiver, which can be emulated in the ACD by sending a fixed open signal OS that emulates several strokes of the original control, transmitting several CCi according to the form OS=ΣSAᵢ=Σᵢf(p, CCi), where OS is synthesized from the parameters pⱼ obtained from the frame Maⱼ and in whose OF all the CCi included in frame CV are reproduced.

According to another mode of execution, when the parameters pj indicate that the OS to be emulated by the ACD corresponds to an evolutive code remote control access system that cannot be emulated by a fixed signal as described in the preceding paragraph, the open signal OS transmitted by an ACD on the basis of an AC is a data function of the type OS=f(pj, CCI). In this case, OS forms whenever the AC is actuated in the ACD with the code CCi immediately following the previously actuated one of the frame CV. For this purpose, the ACD is equipped with memory resources (23) that save the last actuated CCi as reference, in order to select the next CCi in new actuations of the AC, the first CCi of the frame CV being the one used in the first actuation of the open signal OS.

In any of the previous cases, the CCi processed by the platform (2) to form the frame CV of a certain reservation in a certain garage are produced by remote controls of the original manufacturer previously registered in the receiver system (12) of those garages, and therefore the frames CCi, whether for a fixed or evolutive coding control, are known.

Now there is a description of the encryption of the information carried in the AC; this is encoded by means of a secret key K that is known by the ACD and used to decode the encrypted AC.

According to a characteristic of the invention, the secret key K is previously recorded in the memory support (23) of the ACD, normally in an EEPROM.

According to the simplest execution mode, the secret key K used to decode the ACs is the same for all the ACD supports.

In order to prevent the fraudulent use of the ACD devices and enhance system security, other modes of production of keys K are considered.

According to one execution mode of the invention, different keys are used for each ACD device according to its serial number.

According to one execution mode of the invention, the keys K are periodically updatable, and these are supplied to the users (3) so they can be updated in their ACD devices. The user (3) updates keys by means of a key update function f(K) generated by the platform (2) and recognizable by the ACD. According to the type of ACD that the user (3) has, f(K) is input through the keyboard (18), such as the alphanumeric kind (28) shown in figure (2), or directly sent by the platform (2) to the ACD when it is on of the types that have a data reception circuit (16), or else through connection ports (17), where the function f(K) can be input into the ACD from other devices. According to this execution mode, the ACD associated with a user (3) is known by the platform (2), which has a record in its database with the ACD associated with each user by the serial number and a record with the update of keys K of each ACD device.

According to another mode of execution, means have been provided to use different secret keys K for encrypting the AC, such that each key K is unique for each device and reservation, and the key generated by a key production function is known by the ACD, K=f(D,pⱼ) which is linked to the parameters D, which include the period of validity and the serial number of the ACD device, and the radiofrequency signal synthesizing parameters pⱼ. According to this encryption characteristic of the AC, the parameter D and/or pⱼ used in the production function of key K is not encrypted in the AC, but instead is transmitted in a known position in the information frame from the AC to the ACD, for purposes of which the ACD can process the appropriate key K for the AC decoding process.

Since the keys K may differ according to usage time intervals and are generated through a function K=f(D, pⱼ) known by both the platform (2) and the ACD, the latter uses the internal clock 22 in the decoding process, for which purpose the ACDs are synchronized with the platform (2), which has a record in its database with the dates the ACD devices of each user (3) were added.

Thus the ACD receives the AC whose data frame has most of its information encrypted. The ACD uses the appropriate decoding key K. Remember that this key K, according to the encryption execution mode, may be fixed, may have been updated in the ACD after notification to it or to the user (3), or may be linked to a certain time interval D or a parameter pⱼ through a production function known by the ACD, for which purpose the ACD uses its internal clock (22). As mentioned above, according to another characteristic of the invention and in order to enable the encryption process, the ACDs are synchronized with the platform (2) which has a record in its database with the date that the ACD of each user (3) was added and the serial number of the ACD assigned to each user.

According to the invention, the access control is performed in the ACD by logic resources. These are able, on the basis of the frame AC, to decode the information contained in it based on the key K, and to decide if the OS should be thus transmitted on the basis of the access authorization period contained in the frame D.

Once the AC is decoded and in order to determine the validity of the AC, the ACD is provided with an internal clock (22) to compare the information carried in the frame D with the internal clock 22 of the ACD. The ACD also compares the serial number sent as part of the frame D in the AC with the serial number of the control itself, to decide whether or not to transmit the OS signal.

If this verification of both the period of validity and the serial number is positive, the ACD excites the radiofrequency circuit (20) in accordance with the signal synthesizing parameters pⱼ contained in the frame MAⱼ, and modulates the code(s) CCi obtained from the frame CV of the AC, generating an open signal OS compatible with the receiver (12) that will open the door (15).

The ACD is therefore a universal remote control device programmable by electronic ticket, denominated herein access code AC, which enables the ACD to chose the appropriate routine for emulating the different manufacturer protocols, with the above mentioned OS construction variables, and to digitally excite the RF circuit (20) for opening a garage controlled by radiofrequency access systems.

In the case of a variant of a parking garage equipped with means of automatic access control, e.g. in the case of offering garages of type (11) that have access means such as a barrier, gate or door (14) controlled by the parking management and control applications (9) typical of rotating parking garages (11), additional means are provided for access control to the spaces offered by this type of garage and demanded via the exchange platform (2), as well as additional means for interaction between the platform (2) and the garage systems (11) via the receiver (13), as explained hereinafter.

According to this mode of execution, to be able to control access, the parking garage (11) requires the installation of a receiver (13) with:
means for connection: i) to the parking management system (9), ii) to the platform (2), and iii) to the garage access system (14),
means indicated for the detection of the AC presented by a requesting user (3) on accessing the garage (11),
means for calculation, decoding and comparison of the AC received from the user (3) in the receiver (13) with the access code AC and the reservation parameters received from the platform (2), in order to verify the reservation data associated with that AC code, and
means to proceed to open the barrier, gate or door (14).

According to this mode of execution, the platform (2) sends the AC and the reservation identifier RI both to the user (3) and the receiver (13), to which it also sends the data regarding that reservation such as the user details and authorized time interval for the reservation, once the user (3) has confirmed the reservation of a space via the platform (2). The communications between the platform (2) and the receiver (13) for this data exchange include appropriate communication devices in the platform (2) and in the receiver (13) for the exchange of data via Internet, radio messaging or similar for transmission via fixed and/or wireless telephone networks.

For access control and as a data interface with the user (3), the receiver (13) has the indicated means for receiving data through a radiofrequency reception block compatible with the ACD transmitter block, via keyboard or contact cards, such that, in practice, the reservation identifier RI of the user to be input via the keyboard, the frame CCi of the open signal OS transmitted by the ACD of the user (3) and received by the receiver (13), or a contact card associated with the user identifier, can be used as the access code AC to the parking garage (11).

The receiver (13) contains computing means to compare the access code AC received from the user (3) with the reservation data received by the platform (2), in order to verify the reservation and, if positive, to authorize the opening of the garage access system (14).

In order to enable synchronized operation of the receiver device (13) and the access operations linked to a reservation, and the operation of the devices and regular access operations of the access management and control system (9) of the parking garage (11), the receiver (13) contains memory and computing resources for recording and exchanging data with the system (9) and the platform (2) regarding the space reservation, the entry and exit status of assigned reservations, the level of occupation of the garage, and the result of the received AC verification. With regard to the indicated means of communication for data exchange between the receiver (13) and the parking control system (9), these may include USB type fixed communication ports, RS232, RS485 or similar, and/or Bluetooth wireless, wi-fi or similar devices.

In the event of a positive verification of an AC in the receiver (13), this contains means to send an actuation message, either directly to the access system (14) of the barrier type or similar parking garage via a logic signal or an electronic message through an analog output or a communications port connected directly to the access system (14), or else via a communications port connected to the local management and control system (9) of a parking garage operator.

In the case of a variant of a parking garage with manual access control to the garages (11), i.e. done by a supervisor, the access codes AC can be simplified and be in the form of a simple alphanumeric localizer not operable by the ACD, i.e. the reservation identifier RI.

In order to control the access of users (3) to parking garages with manual access control and to validate their reservations, the AC, in this case the RI, is communicated, once the user has confirmed the reservation of a space via the platform (2), to the management and control system (9) of the parking garage (11), if the parking has one.

According to another mode of execution, if the parking garage (11) does not have a management system, these RI codes are notified via telephone through a voice interface that can be interrogated by the offering parking garage (11) affiliated with the platform (2), or else by PC type multimedia devices via Internet. Just as in the case of an offering user (1), the parking garage (11) has query functions via the multi-channel portal (5) regarding reservations of spaces made available to the system by it and the associated RI codes.

In a parking garage (11) with manual access control, the entry and exit of associated reservations is controlled by notification of the RI by the user (3) to the person in charge of garage access control (11).

In accordance with the invention, a simpler execution version is considered, in which the exchange of spaces by a rotating parking lot is managed with the parking itself acting as management platform (2). In an execution of this type, the system and the method for the exchange and shared use of parking spaces can be locally implemented in a parking garage of type (11) to enable the exchange of garage spaces located in residential garages (10) near the parking garage (11) without the intervention of a universal access control device (6).

According to this mode of execution, the platform (2) sends the reservation identifier RI to the user (3) requesting a space located in a parking garage (10) for a reservation processed by the platform (2). For access control to the parking garages (10), the garage (11) is provided with means to store copies of the remote controls of the garages of the offering users (1), which are collected at the beginning of the reservation period and returned at the end by the requesting user (3) from the garage, subject to presentation of the RI to the parking garage supervisor (11).

In order to provide the appropriate copy of the remote control of a parking garage (10) to a user (3), these copies are identified by an information frame, which may be the address of the garage of the associated offering user (1) or a random alphanumeric frame registered in the platform (2) and associated with a reservation, and its RI, made by a user (3).

According to this method of execution, the information frame that identifies a remote control copy is available in a display device secure to the copied control, e.g. a sticker or similar for identification of the control copies by the garage supervisor (11) during the control delivery and collection operations with the user (3).

The invention also provides the system with means to manage incidents and irregular use. To this end, the platform (2) has, among its affiliated garages and suppliers, its own parking space exchange or one agreed on with offering third parties in different parking garages. In order to absorb peak demands and even to solve an irregular use of shared spaces that could give rise to an occupation conflict, methods are provided to resolve incidents. According to this aspect of the invention, if a user of type (3) or (1) finds that the space he has reserved is being used by another user during his period of occupation, procedures are provided to assign another parking space (4).

According to this characteristic of the invention, the user affected by irregular use defines the incident and reports it to the platform (2) via the multi-channel portal (5), and provides the details associated with the occupying vehicle (license plate) and the characteristics of the irregularly occupied space, e.g. space identifier.

The platform (2) processes a new request for occupation in the nearest available parking garage, and issues and sends to the user a new AC code and reservation identifier RI associated with this new parking space.

In accordance with the preceding explanation, the advantageous characteristics of the implementation and use of the invention could be summarized as follows:
according to the described steps and the different modes of execution, the invention provides a system to automatically reserve a parking space according to the availability reported by the offering users, assign the reservation to the requested space, provide the requesting user with means and rights of access to the reserved space, and execute the operations of charging the requesting user for use and depositing the amounts for the offering user by virtue of the contractual conditions of affiliation of users with the platform;
of special relevance is the fact that the access means supplied to the user are independent of the access control system installed in the parking facility, provided the latter is of the type that has reception by radiofrequency or remote control;
also of special relevance is the fact that the security and encryption methods used for the reservation or exchange of parking spaces in this access control system and that are implemented in the AC proper, reside in a separate system, i.e. the access control device or ACD. This avoids the installation of devices and the need to establish verification processes residing in them in residential garages, when the existing access control system is of the type that receives by radiofrequency or remote control. It is important to note that the ACD is compatible with RF receivers and therefore can accommodate rotating parking lots by using a cheap RF access system, as described herein, in parallel with the regular management and control systems of a rotating parking garage. This enables, by means of a low cost system, a dynamic exchange and improved use of unoccupied parking spaces between system users, and in particular it takes advantage of unoccupied spaces of offering users regardless of the nature of the parking garage, whether residential or rotational;
a special advantage is the fact that methods and procedures are provided to assign another parking space (4) when the one originally made available for an assigned reservation or for an available period by the regular user is being occupied by another vehicle.

It is not deemed necessary to enlarge upon the contents of this description for an expert in the field to be able to understand its scope and the advantages derived from the invention, and also to develop and put its object into practice.

Notwithstanding the above, it should be understood that the invention has been described according to a preferential mode of execution and that, therefore, it is subject to variations and modifications embodied in the spirit and scope of the following claims.

1. Access control system comprising:
an exchange station (2) that is provided with:
means for duly identified and subscribed offering users to input offered spaces in accordance with the parameters that define their availability, price, size, and location of the space in the facility;
means for duly identified and subscribed requesting users to define a demand for a parking space in accordance with the parameters they select, according to the available supply, regarding geographical location, size, available occupation period and price;
means for electronic processing of the supply and demand, and means to process and assign an encrypted access code AC to a parking demand linked to a free space according to the available supply, and associated with the access system of the parking garage where the space is located;
means for sending the access code AC, the reservation identifier RI and the characteristic information of the reserved space to a subscribed requesting user; and
means for the electronic recording of completed supply and demand operations, as well as any usage incidents, for the billing of garage space exchange services;
an access control device ACD, as a radiofrequency signal transmitter, for the subscribed requesting user, who actuates it, and which is provided with:
means for AC reception;
computing means to decode the AC corresponding to a certain reservation and to verify the validity of the AC in accordance with the reservation made;
means to process and transmit a radiofrequency open signal OS based on the AC, in order to produce an open signal compatible with the access system of the parking garage where the space corresponding to the reservation is located, and
means for memorizing and replicating ACs normally used by the subscribed requesting user;
a receiver device (13), with:
means of connection to the exchange platform (2);
means for receiving access codes AC, the reservation identifier RI and the characteristic information of the space reserved for a subscribed requesting user by the exchange platform (2);
means for the reception of access codes AC transmitted by an ACD, and
computing means for decoding the AC received from an ACD and for its verification with the reservation information ACs received from the platform (2), to authorize the opening of the access system of the parking garage where the reserved space is located;
suitable means for carrying out the AC information coding process, including the reservation parameters, the access control device ACD used to actuate the AC, and the access system of the garage where the reserved space is located.

2. System according to claim 1, wherein the subscribed users are linked to an ID identifier register of each user in the exchange station.

3. System according to claim 1, wherein each requesting user has an access control device ACD with a unique identifier registered in the exchange station (2).

4. System according to claim 1, wherein the fact that each offered parking space is identified by a display device physically provided in the space, which includes a unique alphanumeric code for that space and which is registered in the exchange platform (2), so that the requesting user can identify the parking space corresponding to his reservation when he accesses the garage.

5. System according to claim 1, comprising means provided in the exchange station (2) to use the localization of the requesting user via the mobile telephone operator, when the method used by that user to request a space is via the mobile telephone network, in order to personalize the supply of parking spaces most suited to the geographical location of the requester.

6. System according to claim 1, comprising means provided in the exchange station (2) to calculate the access code AC that account for the parameters regarding operation of the access system of the reserved space facility, the space reservation, the user identification and the latter's access control device ACD.

7. System according to claim 1, wherein the station (2) has been provided with means for exchanging data between the subscribed users and the station (2) via the fixed or wireless telephone network and applications such as voice recognition interfaces, telephone pulses, SMS text messages, Internet portal and similar, for the purpose of enabling the exchange of data during space supply and demand operations with the subscribed users via different communication channels by means of PC type multimedia devices, electronic agendas, or mobile or fixed phones.

8. System according to claim 1, wherein the station (2) has been provided with a record for each user with the mobile telephone, radio messaging device number or e-mail data, and likewise means have been provided in the station (2) for communication via the fixed or wireless, SMS or radio messaging networks, and/or means via Internet or e-mail, in order to enable the station (2) to send the reservation identifier RI information, the characteristics of the reserved space and the access code AC to the requesting user via the communication channel indicated by the user and/or directly to his associated ACD device.

9. System according to claim 1, wherein the access code AC is a characteristic alphanumeric data frame for those reservations of spaces located on premises with access control systems based on radiofrequency receivers.

10. System according to claim 1, wherein the access code AC is a random alphanumeric data frame that is not executable by the ACD, for reservations of spaces located in garages with supervisor-based manual access control.

11. System according to claim 10, wherein the access code AC is communicated to the supervisor or operator in charge of controlling a garage offering spaces without an access control system, in order to enable him to control the access; it is also communicated to the requesting user for presentation to the supervisor or operator that manually controls the access to a parking garage without an automatic access control system, as proof that he has reserved a parking space.

12. System according to claim 11, wherein the exchange platform has been provided with means so that an offering garage user can consult or receive the expected demands and their parameters, as well as the access code expected of each reservation, and update the actual occupations of those demands (11).

13. System according to claim 9, wherein the access code AC is an alphanumeric frame encrypted by a key K, which can be decoded and verified by the ACD to authorize the radiofrequency transmission of an open signal OS compatible with the radiofrequency receiver of the garage access system.

14. System according to claim 13, wherein the encrypted alphanumeric frame of the AC contains a sub-frame D indicating the usage period of the AC, and a sub-frame with alphanumeric data on the serial number of the ACD to which the AC is assigned; a sub-frame Ma with pⱼ data regarding operation of the access system of the garage where the space is reserved; and a sub-frame CV with the access code or sequence of access codes CCi to be modulated by the ACD for actuation of the garage access system.

15. System according to claim 14, wherein the sub-frame D includes information on the authorized time interval within a daily period, or any combination of days within a weekly, monthly or yearly period that can be verified by the internal clock of the ACD.

16. System according to claim 14, wherein the sub-frame D also includes information on the serial number of the access control device ACD to which the AC is sent, which includes means to compare the serial number received in the sub-frame D with the serial number prerecorded in the ACD in the memory support used.

17. System according to claim 14, wherein the sub-frame Ma is an information function that takes on the form Maⱼ=f(pⱼ), a function that indicates whether the parameters pⱼ are predetermined and recorded in the above mentioned memory supports of the ACD or are transmitted in the frame Maⱼ proper, and where pⱼ are the synthesizing parameters of a radiofrequency signal of a garage remote control that include the frequency, the modulation scheme of the original manufacturer, the work cycle, the fixed or evolutive coding type, and the signal beginning and end header.

18. System according to claim 17, wherein the type of Maⱼ function f(pⱼ) of the AC is identifiable by the ACD, such that the ACD can retrieve the parameters pⱼ from the above mentioned memory supports, or else directly read them from the Maⱼ function sent within the AC in order to use them for construction of the open signal.

19. System according to claim 14, wherein the sub-frame CV of the AC is a data frame CV=f(CCi), which indicates whether the codes CCi to be modulated by the ACD in the open signal OS are predetermined and recorded in the above mentioned memory supports of the ACD, or are transmitted in the frame CV proper of the access code, for which purpose the ACD is provided with means to identify the type of frame CV and thus retrieve the CCi from the above mentioned memory supports, or else directly read them from the function transmitted in the CV.

20. System according to claim 14, wherein, when the parameters pⱼ indicate that the OS to be emulated by the ACD corresponds to a radiofrequency access system of fixed code remote controls, the open signal OS transmitted by an ACD from an AC is a data function of the type OS=åSAᵢ=åᵢ f(pⱼ, CCi) modulated on the basis of the parameters pⱼ obtained and in whose OS all the CCi included in the frame CV are reproduced.

21. System according to claim 14, wherein, when the parameters pⱼ indicate that the OS to be emulated by the ACD corresponds to an access system of evolutive code remote controls, the open signal OS transmitted by an ACD from an AC is a data function of the type OS=f(pⱼ, CCi), whose OS is formed whenever the AC is actuated in the ACD with the code CCi immediately following the one previously actuated in the frame CV, for which purpose the ACD is provided with memory resources to save the last actuated CCi as reference to select the next CCi in new actuations of the AC and where, in the first actuation, the first CCi of the frame CV is the one used to form the OS.

22. System according to claim 14, wherein the CCi processed by the platform (2) for a certain reservation in a certain garage are produced on the basis of remote controls of the original manufacturer previously registered in the receiver system of those garages.

23. System according to claim 13, wherein the secret key K used to encrypt the ACs is the same for all the ACDs in which it is prerecorded in the memory supports used, and this key is renewable in the ACDs.

24. System according to claim 23, comprising means provided in the ACD to periodically update the key K via a key update function generated from the platform (2), and that it can be input, in a similar way as the AC, into the ACD via an appropriate keyboard, connection port or data reception circuit.

25. System according to claim 13, wherein, to prevent the use of codes in other devices, means have been provided to use different secret keys K to encrypt the AC, such that each key K is unique for each device and reservation and the key is generated by a key production function known by the ACD, K=f(D,pⱼ), which is linked to the parameters D of the period of validity and serial number of the ACD control, and to the synthesizing parameters pⱼ of a radiofrequency signal.

26. System according to claim 25, wherein the encryption mode enables the AC to contain unencrypted information to enable the ACD to identify the pⱼ and D used in the key K production function, for which purpose the ACD determines the appropriate encryption key.

27. System according to claim 1, comprising in a version for automated access garages, an appropriate access control receiver device (13) to receive the AC of a user (3) on accessing the parking garage, to verify it with respect to those received from the platform (2) for a space reserved by a requesting user and, in the event of a positive verification, to authorize access to the parking premises of an affiliated offering garage, in order to enable the exchange of parking spaces with offering garages that have automatic access systems.

28. System according to claim 27, wherein the exchange station (2) has been provided with means of communication between the receiver device (13) and the exchange station (2) via the fixed or wireless telephone network, in order to enable the exchange of data on a reservation and its access code directly with the device (13).

29. System according to claim 19, wherein the station (2) communicates the access code AC and the associated reservation parameters to the receiver device (13) of an affiliated offering garage with the above mentioned means of communication associated with it.

30. Access control device (ACD) for the exchange of parking spaces in a system according to claim 1, comprising means to receive alphanumeric access codes AC via a keyboard, USB type fixed data connection ports or similar, Bluetooth type wireless or infrared port or similar, or radio messaging receiver circuit or similar, in order to enable, respectively, the input of the AC into the ACD by pressing on the keyboard, by interaction with other PC type multimedia devices, electronic agendas or mobile phones via the data connection port, or directly by direct reception of the AC sent by the parking space exchange platform (2) to the ACD via its radio message receiver.

31. Access control device according to claim 30, comprising a microprocessor and the means of connection between the microprocessor and the device components, in particular the memory supports, internal clock, display screen, keyboard, connection ports, data reception circuit, battery and radiofrequency transmitter block, for the control thereof and for the control of the device operations of access code input and recording, retrieval and decoding, and actuation of the radiofrequency block according to the parameters transmitted in the AC.

32. Access control device according to claim 30, wherein the memory supports include EEPROM, RAM and ROM memory resources to store and retrieve the AC received or keyed into the ACD, to store the intermediate variables used for decoding the AC and for converting it into an open signal OS, to store tabulated data required for the calculation of intermediate operations, to store regular ACs associated with different transmission channels, to store variables that represent the operating status of the control through the user's strokes on the control's keyboard, and to store the decoding keys and algorithms used to convert the AC into a radiofrequency open signal OS.

33. Access control device according to claim 30, comprising a programmable radiofrequency transmitter block and means to program it, based on the parameters included in the ACs decoded by the ACD, according to different modulation, frequency and coding schemes used in remote controls for garages.

34. Access control device according to claim 30, comprising an internal clock to be able to compare the datum corresponding to a period of validity of the reservation supplied in the AC with the real time datum given by the internal clock.

35. Access receiver device in a system according to claim 27, comprising fixed and/or wireless means of communication for the exchange of data on the parameters of a space reservation, including AC, RI and user identity, the entrance and exit status of assigned reservations, the level of occupation of the garage and the verification result of the ACs received from the user (3), with the local management and control system (9) of a parking garage operator and with the garage exchange station (2).

36. Device according to claim 35, wherein the means of communication of the device (13) with the exchange station (2) include suitable communication devices for exchanging data via Internet and fixed and/or wireless networks, and that the means of communication of the device (13) for exchanging data with the local management and control system (9) include at least one of the means indicated in the group of fixed network communication ports of type USB RS232, RS485 or similar, or Bluetooth type wireless, wi-fi or similar.

37. Device according to claim 27, comprising appropriate computing means for comparing and verifying the access code AC to the parking garage received from the user (3), coming from either the open signals OS of an ACD, a keyboard or a proximity card, with the ACs and their associated reservation parameters, and previously received from the platform (2), in order to authorize the opening of the parking garage access systems (14).

38. Device according to claim 27, comprising means, in the event that the verification is positive, to send an actuation message either directly to the barrier type or similar access system (14) of the parking garage based on a logic signal or an electronic message, via an analog output or a communications port connected directly to the access system (14), or else to send the actuation message via a communications port connected to the local management and control system (9) of a parking garage operator.

39. Method for the exchange of parking garages implemented in a system according to claim 1, wherein each parking space offered by a user is defined by parameters related to its localization, availability, price, size and location in the garage.

40. Method according to claim 39, wherein the exchange station (2) has been provided with means to relate each offered parking space to the parameters regarding the operation and characteristics of its access system (manufacture, transmission frequency, data modulation scheme, and fixed or evolutive coding), in order to correctly process the access codes AC that open the access systems associated with the garages where the parking spaces are located.

41. Method according to claim 39, wherein the exchange station has been provided with means to enable the subscribed user to consult, via the user interfaces of the exchange station (2), the historical of demands and occupations made by him, or made by other requesting users in his offered space, and means to be able to block the execution of his own future reservations in spaces offered by other users or to block the execution of reservations by requesting users who have previously occupied his offered space.

42. Method according to claim 39, wherein the parameters of each parking space demand are related to its localization, duration, price, vehicle size and associated data identifying the vehicle brand, model and license plate.

43. Method for exchanging parking spaces implemented in a system according to claim 1, with the collaboration of an access control device, comprising the following stages:
a) provide a central exchange platform (2);
b) for each requesting user, provide a radiofrequency transmitting access control device ACD, whose characteristics and identifier are registered in the platform (2), and a proximity card with the recorded user identifier;
c) the offering users input into the exchange station (2) the supply of available places along with their characteristics, associated with the user identity in the platform (2);
d) the requesting users input into the exchange station (2) the demand for spaces along with their characteristics, associated with the user identity in the platform (2);
e) register in the platform (2) the characteristics and parameters of the access system of the garages of the offering users;
f) provide a receiver device (13) to the offering garages with an automatic access control system and connect this receiver device (13) to the exchange station (2), to the parking garage local management and control system and to the offering garage access system (14), either directly or else via the parking garage local management and control system (9), to enable actuation of the garage access systems (14) for demands for spaces made through the platform (2) in these offering garages;
g) process the supply and demand in the platform (2) and specify an access code AC for a demand for parking linked to a free space according to the available supply, based on the parameters of the reservation, user and associated ACD, the access system and the type of parking garage where the available offered space is located;
h) confirm the reservation made by the requesting user and, if confirmed, proceed to the next step;
i) send from the platform (2) the access code AC to the requesting user and/or to his access control device ACD;
j) send from the platform (2) a reservation identifier and information on the location of the reserved space to the requesting user;
k) if the reserved space is in an offering garage with supervisor-based access control and without a receiver device (13),
i) the requesting user presents the reservation identifier to the garage supervisor on access;
ii) the supervisor verifies in the platform (2) the reservation characteristics associated with the reservation identifier presented by the user to authorize access;
iii) the supervisor verifies that the user and his vehicle have exited;
iv) if the user and his vehicle enter or exit the facility before or after the established reservation period, the supervisor applies the garage parking conditions outside the hours established for the reservation in terms of right to access and the parking price;
l) if the reserved space is in a residential garage with a radiofrequency access control system and the requesting user has an access control device (ACD), the requesting users input and actuate the received AC on accessing and exiting the facility where the space linked to their demand is located:
i) the ACD generates an open signal in accordance with the parameters indicated in the AC to actuate the residential garage access control system in order to enter and exit it;
ii) if the requesting user finds that the garage space is occupied by another vehicle, the requesting user reports to the exchange station (2) the characteristics associated with the reservation identity, the identity of the occupying vehicle (license plate) and the characteristics of the occupied space (space identifier), and the data corresponding to this irregular occupation are recorded in the platform (2);
iii) in the preceding case, the platform (2) processes a new request for occupation similar to that of the requesting user in the nearest available parking garage, and issues and sends to the requesting user a new AC associated with this new reservation, as well as a new reservation identifier and information on the localization of the space;
iv) if the requesting user occupies the reserved space for longer than the time assigned in the reservation and an offering user finds his space irregularly occupied on return, the offering user reports to the exchange station (2) the characteristics associated with the identity of the occupying vehicle (license plate) and the characteristics of the occupied space (space identifier), and the data corresponding to this irregular occupation are recorded in the platform (2);
v) in the preceding case, the platform (2) processes a new request for limited occupation until the next period of availability expected in the space offered by the offering user in the nearest available parking garage, and issues and sends to the offering user a new AC associated with this new reservation, as well as a new reservation identifier and information on the localization of the space;
m) if the reserved space is in a residential garage with a radiofrequency access control system and the requesting user does not have an access control device (ACD),
i) the requesting user presents the reservation or user identifier to the garage supervisor to receive a copy of the remote control of the garage where the reservation has been made at the beginning of the reservation period, as well as to return the remote control copy at the end of the reservation period;
ii) the supervisor verifies in the platform (2) the characteristics of the reservation associated with the reservation identifier presented by the user to hand over and control the collection of the copy of the remote control of the garage where the reservation has been made;
iii) if, when the requesting user accesses the garage where the space is reserved and finds that it is occupied by another vehicle, the requesting user reports to the exchange station (2) the characteristics associated with the reservation identity, the identity of the occupying vehicle (license plate) and the characteristics of the occupied space (space identifier), and the data corresponding to this irregular occupation are recorded in the platform (2);
iv) in the preceding case, the platform (2) processes a new request for occupation similar to that of the requesting user in the nearest available parking garage, and issues and sends to the requesting user a new AC associated with this new reservation, as well as a new reservation identifier and information on the localization of the space;
v) if the requesting user occupies the reserved space for longer than the time assigned in the reservation and an offering user finds his space irregularly occupied on return, the offering user reports to the exchange station (2) the characteristics associated with the identity of the occupying vehicle (license plate) and the characteristics of the occupied space (space identifier), and the data corresponding to this irregular occupation are recorded in the platform (2);
vi) in the preceding case, the platform (2) processes a new request for limited occupation until the next period of availability expected in the space offered by the offering user in the nearest available parking garage, and issues and sends to the offering user a new AC associated with this new reservation, as well as a new reservation identifier and information on the localization of the space;
n) if the reserved space is in an offering parking garage with automatic access control and a receiver device (13):
i) the platform (2) sends the access code AC, the reservation identifier, the user identifier and its characteristics to the device (13);
ii) the requesting users transmit to the receiver (13) the received AC, either via keyboard, OS by ACD actuation or proximity card, on accessing or exiting the premises where the space linked to their demand is located;
iii) the device (13) receives the AC and compares it to the reservation characteristics received from the platform (2);
iv) in the event of positive verification within the assigned reservation period, the device sends an actuation message to the access system (14), either directly when the device (13) is connected to the access system (14) or else via the parking garage local management and control system (9), and records the vehicle presence status in the parking garage and also sends the data on the occupation status of the assigned reservations to the central platform (2) and to the parking garage local management and control system (9);
v) if the user and his vehicle report the AC to the receiver (13) to enter the premises before the established reservation period, the device sends an actuation message to the parking garage local management and control system (9), which will determine, as is usually the case in these systems, the right to access the facility in terms of level of occupation and, if permission is given, it records the actual access conditions (entrance time) and the level of occupation in the device (13) and sends them to the central platform (2) and to the parking garage local management and control system (9), to determine the price for parking outside the established reservation hours;
vi) if the user and his vehicle actuate the ACD to exit the premises after the hour established in the reservation period, it sends an actuation message to the parking garage local management and control system (9), records the actual access conditions (exit time) and the level of occupation in the device (13) and sends them to the central platform (2) and to the parking garage local management and control system (9), to determine the price for parking outside the established reservation hours.
